(19) United States
(12) Patent Application Publication
(10) Pub. No.: US 2011/0000985 A1
(43) Pub. Date: Jan. 6, 2011

(54) Sprinkler Apparatus

(76) Inventor: David James Drake, Hampshire (GB)

Correspondence Address: BYIP, LTD., P.O. BOX 1484, GENERAL POST OFFICE, HONG KONG, HK

(21) Appl. No.: 12/866,240

(22) PCT Filed: Jan. 28, 2009
(86) PCT No.: PCT/GB09/00235

§ 371 Date: Aug. 5, 2010

(30) Foreign Application Priority Data
Feb. 9, 2008 (GB) 0802438.2

(51) Int. Cl. A01C 17/00

(52) U.S. Cl. 239/681

(57) ABSTRACT

A sprinkler apparatus (10) comprises a container (12) for containing a powder to be sprinkled, a stencil (24) disposed at one end of the container (12) and dispensing means for controllably dispensing powder contained in the container (12) through the stencil (24). The dispensing means includes a movable blade (26) which is disposed within the container (12) immediately adjacent and overlying the stencil (24). The blade (26) has at least one opening (34, 36) therein for allowing powder contained in the container (12) to pass through the opening (34, 36) and through the stencil (24).

The present invention relates to a sprinkler apparatus and particularly but not exclusively to a sprinkler apparatus for sprinkling powder, such as a confectionary powder onto the top of a drink, dessert or cake.

It is known to provide a stencil for applying powder to drink, such as a cappuccino or latte, in order to decorate the top of the drink. Typically chocolate flavoured powder, cocoa powder or cinnamon powder are sprinkled from a sprinkler over a hand held stencil positioned over the drink. The powder falls onto the stencil and passes through apertures in the stencil to form a desired pattern on the top of the drink. Similarly, stencils are used to decorate deserts, for example ice cream, and cakes. Depending on the size of apertures in the stencil, the powder may be icing sugar, castor sugar or even coloured and flavoured sugar strands.

A problem of using stencils and sprinklers in this way, is that the powder is spread over the whole of the stencil and usually around the outside of the stencil. The majority of powder applied is wasted and the process is extremely messy, with powder often ending up on, for example, the coffee cup and surrounding surfaces. In a coffee shop, cleanliness is extremely important, and the waste powder has to be regularly cleaned up, resulting in downtime for staff serving customers.

According to the present invention there is provided a sprinkler apparatus comprising a container for containing a powder to be sprinkled, a stencil disposed at one end of the container and dispensing means for controllably dispensing powder contained in the container through the stencil, the dispensing means including a movable blade which is disposed within the container immediately adjacent and overlying the stencil, the blade having at least one opening therein for allowing powder contained in the container to pass through the opening and through the stencil.

It is an advantage of the invention that because the powder can be controllably dispensed through the stencil, no powder is wasted and no mess is created.

A stencil is defined as a planar member with one or more through apertures in the planar member arranged in the shape of a desired pattern or image.

Preferable and/or optional features of the invention are set forth in claims 2 to 12, inclusive.

For a better understanding of the present invention, and to show more clearly how it may be carried into effect, reference will now be made, by way of example, to the accompanying drawings, in which:

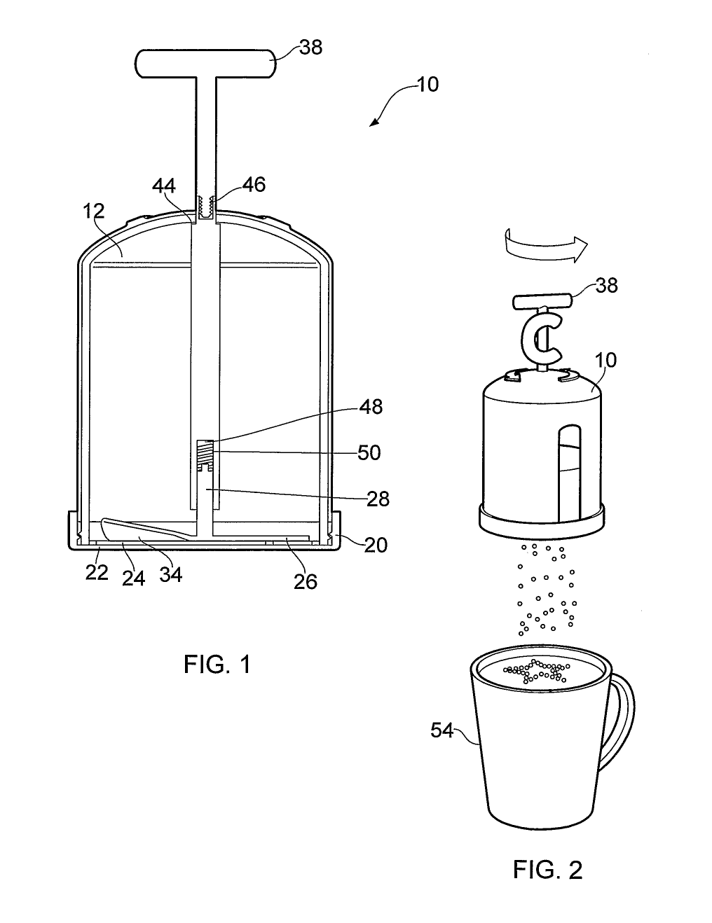

FIG. 1 shows a schematic cross-sectional view through a sprinkler apparatus of the invention;

FIG. 2 shows a perspective view of the sprinkler apparatus of FIG. 1, in use, sprinkling chocolate powder onto a cup of coffee;

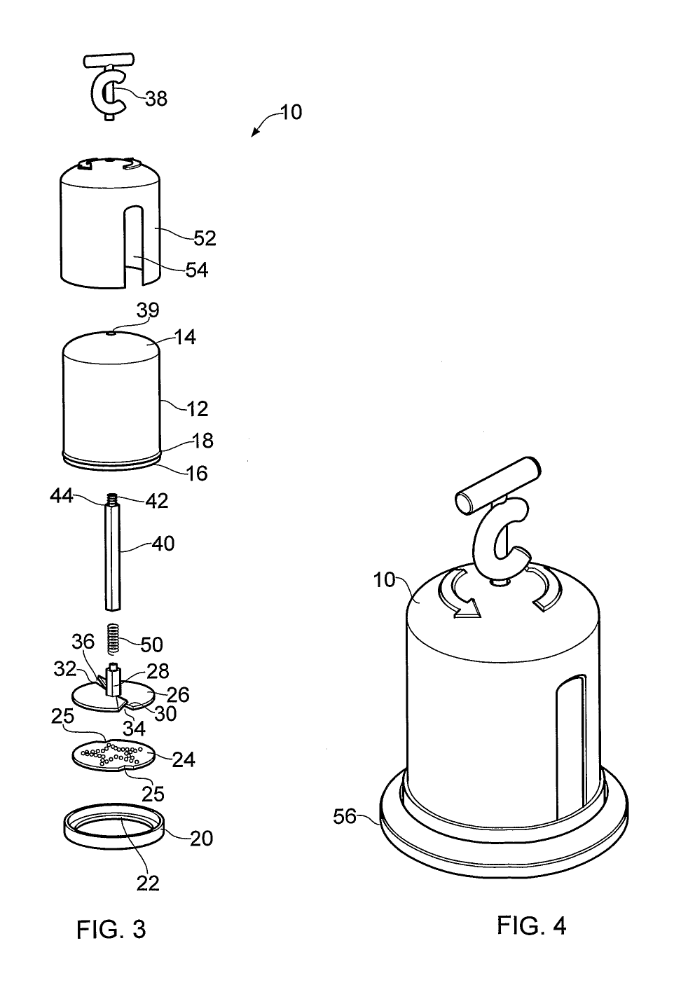

FIG. 3 shows a schematic perspective exploded view of the sprinkler apparatus of FIG. 1; and

FIG. 4 shows a schematic perspective view of the sprinkler apparatus of FIG. 1 resting on a base member.

Referring firstly to FIGS. 1 and 3 a sprinkler apparatus is indicated generally at 10. The sprinkler apparatus 10 comprises a substantially cylindrical container 12, which is domed at an upper end 14 and open at a lower end 16. The outer periphery of the container 12 around the lower end 16 is screw threaded at 18 to receive a correspondingly screw threaded cap or retainer 20. The retainer 20 does not close the end of the container 12, but has a circumferential lip 22 extending inwardly from the periphery of the retainer 20. A substantially circular stencil 24 locates in the open end 16 of the container 12 and is held in the container by the lip 22 of the retainer 20, when the retainer is screwed onto the base of the container.

The stencil 24 has two detents or cut outs 25 in its periphery, which locate on corresponding formations (not shown) on the lower inside wall of the container 12. When the detents 25 are located on the formations, the stencil is prevented from rotating relative to the container 12 and is also prevented from moving substantially into the container 12. The stencil 24 is a planar member having apertures therein in a shape or pattern to be recreated in powder dispensed from the container 12, as discussed below.

A circular blade 26 is disposed in the container 12 and rests directly on the stencil 24. The blade 26 is a substantially planar disc, with a perpendicular drive member or shaft 28 extending perpendicularly upwards from its centre, aligned with a central axis of the container 12. First and second diametrically opposed substantially radial slits or cuts 30,32 are provided in the blade 26 and extend from a central region of the blade proximate the drive shaft 28. The material of the blade 26 is folded upwards at an angle of approximately 10 to 20 degrees on one side of each slit 30,32 to create respective angled openings 34,36 between the surface of the stencil 24 and the internal cavity of the container 12. The folded material is diametrically opposed, so that the mouths of the openings 34,36 face the same angular direction. Each portion of folded material presents a face angled upwards from the upper surface of the blade to expose one or more apertures in the stencil below to the container.

A handle 38 is disposed at the upper end of the container 12 and is arranged to be in driving engagement with the drive shaft 28 of the blade 26. An aperture 39 is provided at the centre of the domed end 14 of the container 12. A drive shaft 40 is located inside the container and at an upper end has a reduced diameter portion 42 extending from a shoulder 44. The shoulder 44 abuts the underside of the domed end of the container and the reduced diameter portion 42 extends through the aperture 39. The handle 38 is connected to the reduced diameter portion 42 by a screw thread 46. The lower end of the drive shaft 40 is recessed with a circular aperture 48, which slides over and engages with the end of the drive shaft 28 of the blade 26. Engagement means (not shown), for example a formation and slot are provided on the shaft 28 and in the recess 48 to facilitate the passing of drive from the shaft 40 to the shaft 28. A spring 50 is located on a spigot of reduced diameter at the end of the shaft 28 and biases the blade 26 downwards against the stencil 24.

The container 12 is transparent and a cover member or sleeve 52 is shaped to slide over the container with a tight fit. The sleeve 52 has slots 54 cut in either side to enable the level of the contents of the container 12 to be viewed. Arrows are also disposed on the end of the sleeve 52, to facilitate use of the apparatus 10 as described below. The sleeve 52 also provides areas for advertising matter to be displayed.

In use, the screw threaded cap 20 can be removed, the stencil 24, blade 26 and spring 50 removed, and the container 12 filled with powder, for example, chocolate powder to be sprinkled. The spring 50, blade 26, stencil 24 and end cap 20 are then replaced. The sprinkler 10 can then be positioned over an item to be sprinkled, for example, a cup of coffee 54 as indicated in FIG. 2. The handle 38 is then rotated in the direction of the arrows, causing the blade 26 to be rotated. Powder contained in the container 12 passes through the mouths of the openings 34,36 and is forced through the apertures in the stencil by the angled faces of the folded up portions of the blade 26. The close proximity of the blade 26 to the stencil 24 under the downward bias of the spring 50 ensures that powder only passes through the apertures in the stencil, when located in the openings 34,36. On rotation of the handle through 180°, each opening traverses through a separate 180° portion of the stencil 24 and powder from the container 12 is dispensed in the full pattern of the stencil.

When the sprinkler is not in use, the powder in the container does not fall freely through the or each aperture in the stencil because the majority of the stencil 24 is closely covered by the blade. Furthermore, in the positions of the openings 34,36, the folded portions still substantially cover and protect the exposed stencil areas against the weight of powder from above. Thus, only powder contained below the folded portions can potentially fall through the stencil apertures.

In a modification to the embodiment described above, the handle may be removable and interchangeable, so that a specific handle representative of the user or user's company can be utilised.

Furthermore, to provide for use when turning the handle in either direction, for example when being used by a left-handed person, at least one of the openings, or further provided openings, are included having angled faces which face in the opposite direction.

Although the angled faces of the disc-like blade are formed by folded portions, the blade may be cast or moulded, thus dispensing with the need for folding whilst still providing the angled faces.

The container is filled from the base, as described above, but may include a top opening and/or cap whereby the container can be filled from the top without having to remove the stencil.

The invention is advantageous because substantially no powder is wasted and the image of the stencil 24 is cleanly produced in the powder. The stencil 24 can easily be changed for another stencil depicting another pattern. The sprinkler can be used for decorating drinks, desserts or any foodstuff. The apertures in the stencil can also be made in a variety of sizes to enable sprinkling of granules of varying sizes. Referring to FIG. 4, when the sprinkler is not in use, it is placed on a recessed base 56, which contains any escaping powder or other decorative substance.

1-13. (canceled)

14. A sprinkler apparatus comprising a container for containing a powder to be sprinkled, a stencil disposed at one end of the container and dispensing means for controllably dispensing powder contained in the container through the stencil, the dispensing means including a movable blade which is disposed within the container immediately adjacent and overlying the stencil, the blade having at least one opening therein for allowing powder contained in the container to pass through the opening and through the stencil.

15. A sprinkler apparatus as claimed in claim 14, wherein the blade is biased into contact with the stencil.

16. A sprinkler apparatus as claimed in claim 14, wherein the stencil is circular and the movable blade is circular or substantially circular.

17. A sprinkler apparatus as claimed in claim 14, wherein the movable blade is mounted for rotation about a central axis.

18. A sprinkler apparatus as claimed in claim 17, wherein a handle is connected to the blade by means of a drive shaft, rotation of the handle causing rotation of the blade.

19. A sprinkler apparatus as claimed in claim 18, wherein the handle is interchangeable.

20. A sprinkler apparatus as claimed in claim 14, wherein the movable blade is disc-like and covers or substantially covers the entire stencil.

21. A sprinkler apparatus as claimed in claim 14, wherein the opening is formed by making a substantially radial cut in the blade from its periphery to a position proximate its centre, folding a portion of the blade upwards to create a face angled upwards from the upper surface of the blade, in use, rotation of the blade causing the angled face to draw in powder from the container and force it through apertures in the stencil underneath the folded portion.

22. A sprinkler apparatus as claimed in claim 14, wherein the opening is or is substantially radial, and the blade includes an upwardly angled face for directing powder from the container through the opening.

23. A sprinkler apparatus as claimed in claim 21, wherein at least two diametrically opposed substantially radial openings are provided in the blade.

24. A sprinkler apparatus as claimed in claim 23, wherein the said angled faces have different orientations, so that rotation in either direction of the blade causes powder to be drawn from the container and forced through apertures in the stencil.

25. A sprinkler apparatus as claimed in claim 14, wherein the stencil is removably retained in an open end of the container by a screw cap.
